(19) United States
(12) Patent Application Publication
(10) Pub. No.: US 2016/0039347 A1
(43) Pub. Date: Feb. 11, 2016

(54) RETRACTABLE CARGO COVER

(71) Applicant: Haion Won, Basking Ridge, NJ (US)

(72) Inventor: Haion Won, Basking Ridge, NJ (US)

(21) Appl. No.: 14/455,025

(22) Filed: Aug. 8, 2014

(51) Int. Cl. B60R 5/04

(52) U.S. Cl. CPC B60R 5/045

(57) ABSTRACT

A retractable cargo covers for automotive vehicles such as SUVS and wagons. The retractable cargo cover has two ends, one end being attached to a rod or a pole that is connected to an inner most end of an inside back area of an automotive vehicle said rod having two ends attached or placed between side ends of side walls of the automotive vehicle. Another end of the retractable cargo cover has two corners attached to a respective string of one of two respective retractable string reels and each of said two respective string reels is connected or attached to a midway point on each side of a rear door of the automotive vehicle so that in a first position the retractable cargo cover is lifted above the items in the vehicle that the retractable cargo cover is to cover with the rear door of the vehicle open and in second position the retractable cargo cover covers the items in the vehicle with the rear door of the vehicle closed.

### BACKGROUND

1. Field

The present invention relates to an improved retractable cargo cover for automotive vehicles such as suburban vehicles (SUVs) and wagons. In particular the present invention provides for a retractable cargo cover that is easy to use, lightweight, fuel efficient and can accommodate covering items in a vehicle that can be relatively high in height.

2. The Related Prior Art

Conventional cargo covers require large sized springs in order to retract the cargo cover as well as big casings to contain the cover and a spring mechanism installation. Due to the requirement of these multiple heavy parts, conventional cargo covers weigh anywhere from 5.8 to 22 lbs. It would be desirable to provide a retractable cargo cover that is lightweight weighing less than 1 lb, having a lower manufacturing cost and that is environmentally friendly by being lighter weight and thus consuming less gasoline since the vehicle would be lighter.

### SUMMARY

The present invention provides a retractable cargo cover in which two retractable string reels are attached to the interior sides of the rear door of a vehicle such as an SUV or a wagon and the ends of the string reels have attachment components such as hooks that connect to eyelets on a rod attached to an end of a cargo cover so that when the door is opened the cargo cover lifts up and items can be stored under the cover and when the door is closed the cover pulls down and covers the items in the vehicle. The present invention provides for a much lighter retractable cargo cover than the conventional ones currently in the market place. In addition the present invention provides for an environmentally friendly, gas efficient retractable cargo cover that is easy for user access for storing and removing luggage items from the vehicle with a mechanism that is easier to install. The present invention further provides for a retractable cargo cover mechanism that avoids the four movements required each time for a conventional mechanism since the cargo cover of the present invention covers and retracts based upon whether the rear vehicle door is opened or closed thus providing for a simple, time efficient method and apparatus than is provided by the prior art.

### BRIEF DESCRIPTION OF THE DRAWINGS

FIG. 1 is a partial side view of a rear portion of a vehicle with the rear door open for the present invention;

FIG. 2 is a partial side view of a rear portion of a vehicle with the rear door closed for the present invention;

FIG. 3 is a full rear view of the rear portion of a vehicle with the rear door open for the present invention;

FIG. 4 is a partial side view of a rear portion of a vehicle for the present invention showing how it accommodate stall items stored in the vehicle under the retractable cargo cover with the rear door of the vehicle open;

FIG. 5 is a partial side view of a rear portion of a vehicle for the present invention showing how it accommodates all items stored in the vehicle under the retractable cargo cover with the rear door of the vehicle closed;

FIGS. 6A, 6b and 6C illustrate one embodiment of the present invention in which:

FIG. 6A shows a partial top view of the plastic rod having a flexible hollowed out plastic end for removably attaching the rod to the interior sidewalls of the vehicle and hooks for detachably connecting the cover to the corners of the rear of the vehicle there by detachably connecting the cargo cover to the vehicle;

FIG. 6B shows a detailed close up view how the cover and rod are installed in the vehicle; and

FIG. 6C shows how the hollowed plastic end of the rod can be compressed for installation and for removal of the rod and the cargo from the interior sidewalls of the vehicle; and

FIGS. 7A, 7b and 7C illustrate another embodiment of the present invention in which:

FIG. 7A shows a partial top view of the plastic rod having one rubber end for removably attaching the rod to the interior sidewalls of the vehicle and hooks for detachably connecting the cover to the corners of the rear of the vehicle there by detachably connecting the cargo cover to the vehicle;

FIG. 7B shows a detailed close up view how the cover and rod are installed in the vehicle; and

FIG. 7C shows how the rubber end of the rod can be compressed for installation and for removal of the rod and the cargo from the interior sidewalls of the vehicle.

### DETAILED DESCRIPTION OF THE PREFERRED EMBODIMENT(S)

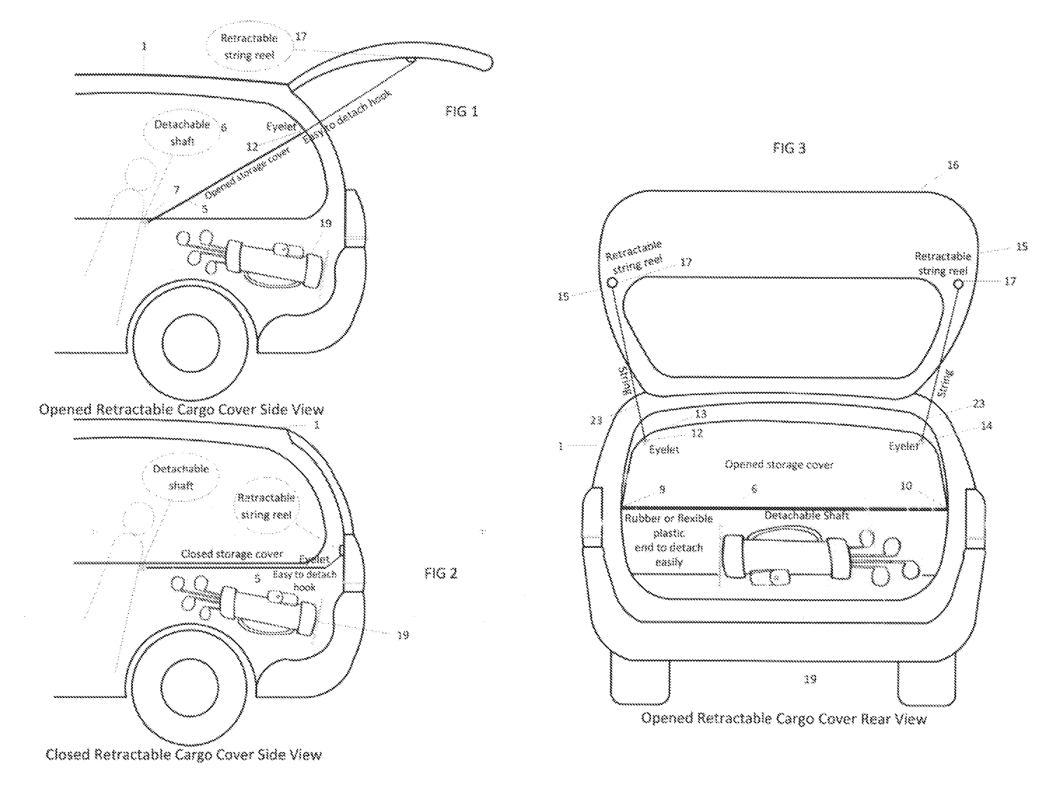

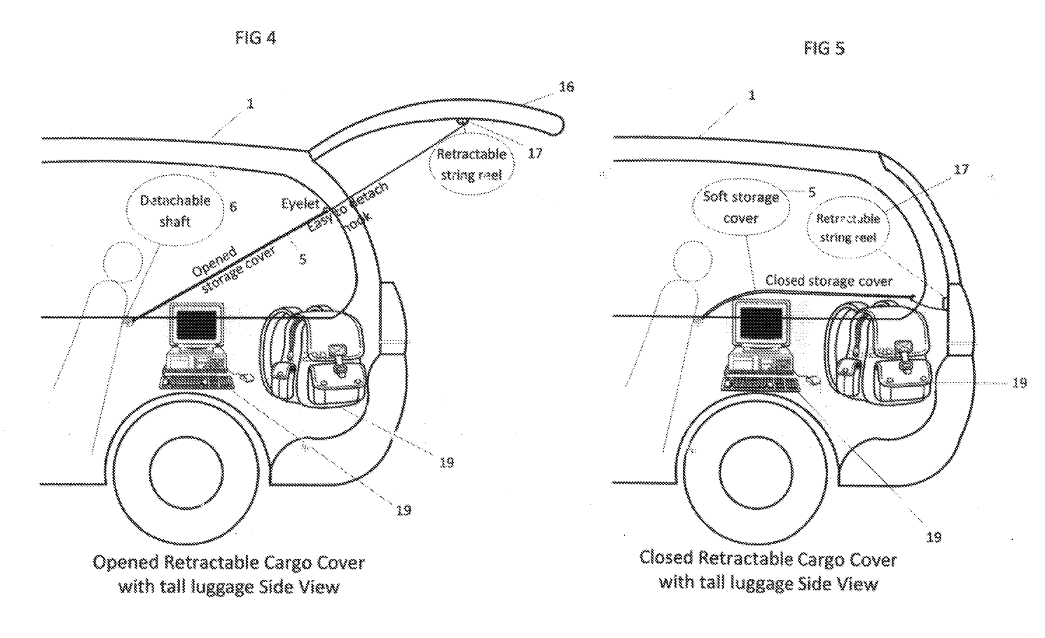

Referring now to the drawings of FIGS. 1-5, the present invention relates to a retractable cargo cover 5 for use in vehicles 1 such as but not limited to suburban vehicles (SUVs) and wagons such as but not limited to station wagons. The present invention is for a retractable cargo cover 5 (see FIGS. 1 and 2) suited for automotive vehicles 1 notably SUVs and wagons. The retractable cargo cover 5 is preferably made of a durable flexible material and has preferably two ends, one end 7 attached to a rod or a pole 6, connected to the inner most end of the inside back area of the automotive vehicle 1 (see FIG. 3) The rod 6 can be preferably formed almost entirely of plastic 1 except for one of two ends and the rod 6 has two ends 9, 10 that are attached or placed between the side ends of the side walls of the automotive vehicle 1 (see FIG. 3). One of these ends 9 (see FIG. 3 has either a rubber end attached to it or made of hollow plastic so as to deform so that the rod can be easily installed upon or removed from the vehicle. The other end of the cargo cover 8 has two corners 13, 14 that attaches by hooks and eyelets 17 or other connecting devices to a respective string of a retractable string reel 14 at one end of the respective reels 14 and the respective reels 14 being connected or attached to a midway point 15 on each side for each respective one of the reels 4 of the rear door 16 of the automotive vehicle 1 as shown in FIG. 3. The retractable steel string rings can be provided by commercially available reels in the market place including but not limited to RT-11-CP and RT 338-CP-8.

FIG. 1 shows the present invention in a first position with the retractable cargo cover lifted above the items 19 it is to cover with the rear door 16 of the vehicle 1 open. FIG. 3 shows the retractable cargo cover 5 in a second position covering the items 19 in the automotive vehicle 1 with the rear door 16 closed.

Similarly FIG. 4 shows the present invention in the first position with the retractable cargo cover lifted above the items 19 it is to cover with the rear door 16 of the vehicle 1 open. In FIG. 4 the items 19 are items of considerable height but as can be seen in FIG. 5 with the retractable cargo cover 5 in the second position, the retractable cargo cover 5 of the present invention can conform to the height levels of the items and still cover the items 19 in the automotive vehicle 1 with the rear door 16 closed.

The retractable cargo cover 5 of the present invention provides for a much lighter retractable cargo cover 5 than the conventional ones. The retractable cargo cover 5 of the present invention is an environmentally friendly, gas efficient retractable cargo cover that is easy for user access for storing and removing luggage items from the vehicle with a mechanism that is easier to install. The retractable cargo cover mechanism of the present invention avoids the four movements required each time for a conventional mechanism, since the retractable cargo cover 5 of the present invention covers and retracts based upon whether the rear vehicle door is opened or closed thus providing for a simple, time efficient method and apparatus than was previously known.

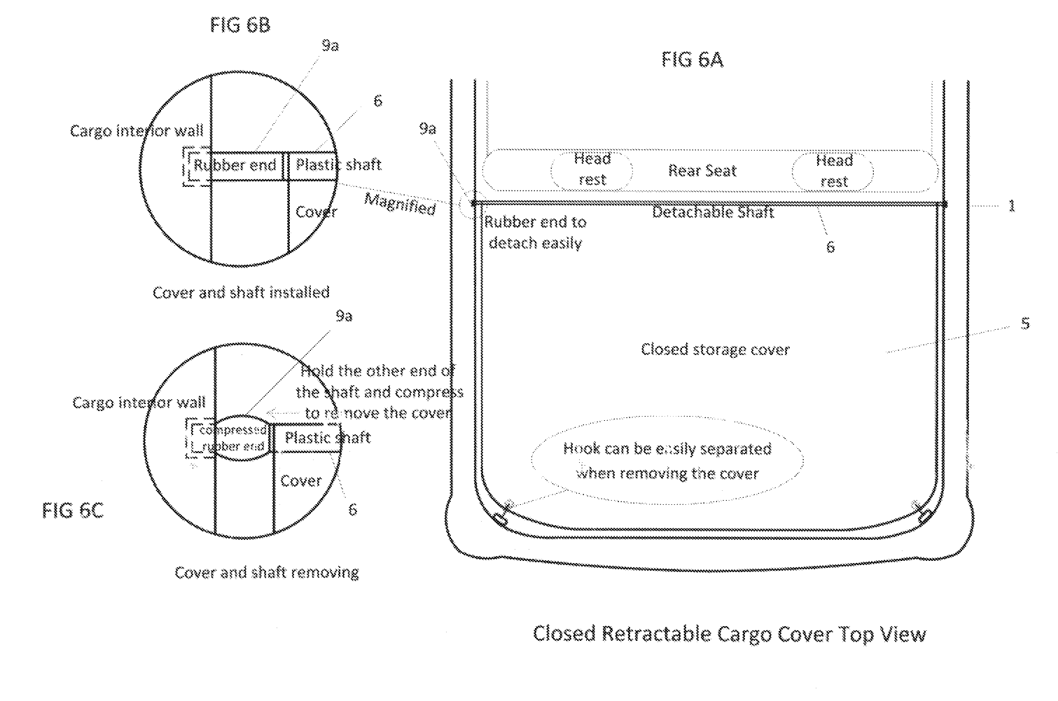

FIGS. 6A, 6b and 6C demonstrate a first embodiment of the present invention. In FIG. 6A the plastic rod 6 having a flexible hollowed out plastic end 9a for removably attaching the rod 6 to the interior sidewalls of the vehicle and hooks 17 for detachably connecting the cover 5 to the corners of the rear of the vehicle 1 there by detachably connecting the cargo cover 5 to the vehicle 1. FIG. 6B shows this in a detailed close up view how the cover 5 and rod 6 are installed in the vehicle 1 by means of the rubber end 9a of the rod 6 compressing against one of the interior sidewalls of the vehicle 1 and the hooks 17 and eyelets 17 attaching to each other. FIG. 6C shows the hollowed plastic end 9a of the rod 6 being compressed for installation and for removal of the rod 6 and the cargo 5 from the interior sidewalls of the vehicle.

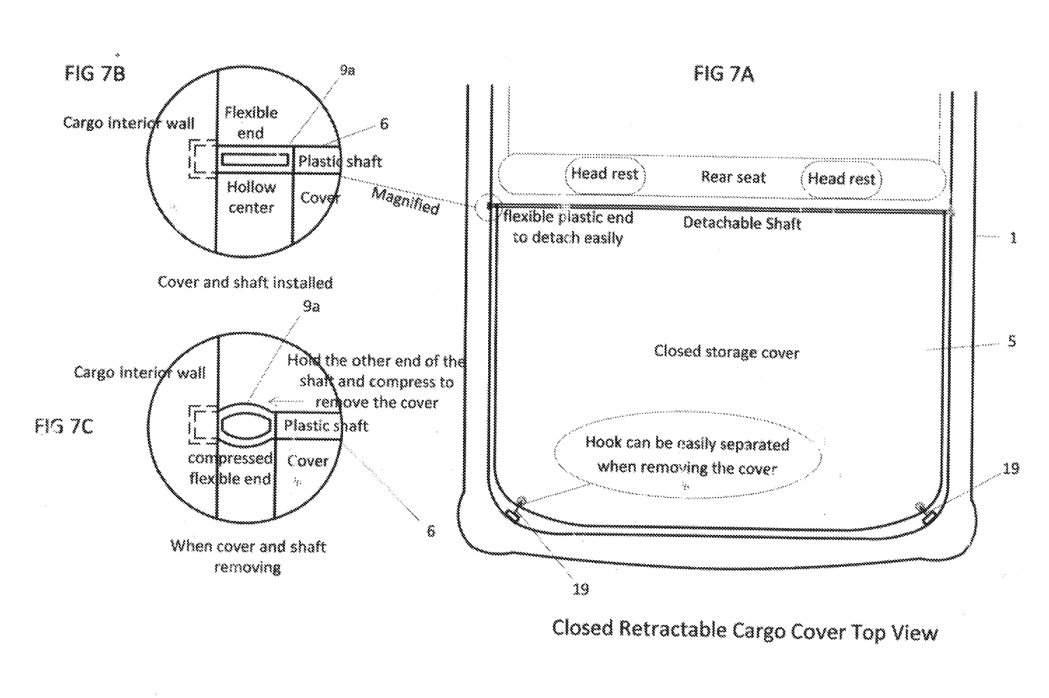

FIGS. 7A, 7b and 7C illustrate a second embodiment of the present invention in which FIG. 6A shows that the plastic rod 6 has one rubber end 9a for removably attaching the rod 6 to the interior sidewalls of the vehicle 1 and hooks 17 for detachably connecting the cover to the eyelets at the corners of the rear of the vehicle there by detachably connecting the cargo cover 5 to the vehicle 1. FIG. 6B shows a detailed close up view how the cover 5 and rod 6 are installed in the vehicle 1. FIG 6C shows the rubber end 9a of the rod 6 compressed for installation and for removal of the rod 6 and the cargo 5 from the interior sidewalls of the vehicle 1.

While presently preferred embodiments have been described for purposes of the disclosure, numerous changes in the arrangement of apparatus parts can be made by those skilled in the art. Such changes are encompassed within the spirit of the invention as defined by the appended claims.

What is claimed:

1. A retractable cargo cover for automotive vehicles such as SUVS and wagons, comprising:
a retractable cargo cover having two ends, one end being attached to a rod or a pole that is connected to an inner most end of an inside back area of an automotive vehicle said rod having two ends attached or placed between side ends of side walls of the automotive vehicle; another end of said retractable cargo cover having two corners attached to a respective string of one of two respective retractable string reels and each of said two respective string reels being connected or attached to a midway point on each side of a rear door of the automotive vehicle so that in a first position the retractable cargo cover is lifted above the items in the vehicle that the retractable cargo cover is to cover with the rear door of the vehicle open, and in second position the retractable cargo cover covers the items in the vehicle with the rear door of the vehicle closed.

2. The retractable cargo cover according to claim 1 wherein one of said ends of said rod is made of rubber to facilitate the installation or removal of the rod from the vehicle.

3. The retractable cargo cover according to claim 1 wherein one of said ends of said rod is made of plastic so as to deform so that the rod can be easily installed upon or removed from the vehicle.

4. The retractable cargo cover according to claim 1 wherein the other end of the cargo cover has two corners that attaches to respective retractable string reel 14 at one end of the respective reels and the other end of the respective reels being connected or attached to an eyelet or other mounting or connecting device for connecting that end of the reel to a midway point on each side for each respective one of the reels of the rear door of the automotive vehicle.

5. The retractable cargo cover according to claim 1 wherein said retractable cargo cover is adaptable to conform to various heights of items stored in the vehicle and to cover these items.

6. The retractable cargo cover according to claim 1 wherein said cargo cover is attached to a length of said rod along its longitudinal axis and said rod is formed of plastic and has a flexible hollowed out plastic end for removably attaching the rod to the interior sidewalls of the vehicle and hooks for detachably connecting the cover to eyelets at the corners of the rear of the vehicle so that said hollowed plastic end of the rod is compressed for installation and for removal of the rod and the cargo from the interior sidewalls of the vehicle.

7. The retractable cargo cover according to claim 1 wherein said cargo cover is attached to a length of said rod along its longitudinal axis and said rod is formed of plastic and has a rubber end for removably attaching the rod to the interior sidewalls of the vehicle and hooks for detachably connecting the cover to eyelets at the corners of the rear of the vehicle so that said rubber end of the rod is compressed for installation and for removal of the rod and the cargo from the interior sidewalls of the vehicle

8. A method for providing a retractable cargo cover for automotive vehicles such as SUVS and wagons, the steps comprising:
providing a retractable cargo cover having two ends, attaching one end to a rod or a pole that is connected to an inner most end of an inside back area of an automotive vehicle attached or placed said rod having two ends between side ends of side walls of the automotive vehicle; attaching another end of said retractable cargo cover having two corners by attaching each of said two corners attached to a respective string of f one of two respective retractable string reels and each of said two respective string reels being connected or attached to a midway point on each side of a rear door of the automotive vehicle so that in a first position the retractable cargo cover is lifted above the items in the vehicle that the retractable cargo cover is to cover with the rear door of the vehicle open, and in second position the retractable cargo cover covers the items in the vehicle with the rear door of the vehicle closed.

9. The method according to claim 8 wherein said cargo cover is attached to a length of said rod along its longitudinal axis and said rod is formed of plastic and has a flexible hollowed out plastic end for removably attaching the rod to the interior sidewalls of the vehicle and hooks for detachably connecting the cover to eyelets at the corners of the rear of the vehicle so that said hollowed plastic end of the rod is compressed for installation and for removal of the rod and the cargo from the interior sidewalls of the vehicle.

10. The method according to claim 8 wherein said cargo cover is attached to a length of said rod along its longitudinal axis and said rod is formed of plastic and has a rubber end for removably attaching the rod to the interior sidewalls of the vehicle and hooks for detachably connecting the cover to eyelets at the corners of the rear of the vehicle so that said rubber end of the rod is compressed for installation and for removal of the rod and the cargo from the interior sidewalls of the vehicle
